(19) United States
(12) Patent Application Publication
(10) Pub. No.: US 2014/0164009 A1
(43) Pub. Date: Jun. 12, 2014

(54) System and Method for Patient Attribution in a Healthcare Setting

(71) Applicant: Applied Research Works, Inc., Palo Alto, CA (US)

(72) Inventors: Shaibal Roy, Palo Alto, CA (US); Subhendu Aich, Palo Alto, CA (US); Mark Feinholz, Redwood City, CA (US)

(73) Assignee: Applied Research Works, Inc., Palo Alto, CA (US)

(21) Appl. No.: 14/092,913

(22) Filed: Nov. 27, 2013

Related U.S. Application Data
(60) Provisional application No. 61/730,502, filed on Nov. 27, 2012.

(51) Int. Cl. G06Q 50/22

(52) U.S. Cl. CPC G06Q 50/22; G06Q 40/08
USPC 705/2

(57) ABSTRACT

Disclosed herein is a method and system for attributing patients to a physician panel in a healthcare setting. Attribution can occur either implicitly, through the use of claims data or an inference based on clinical encounters, or explicitly by way of manual entry of supplemental data into a system.

### PRIORITY CLAIM

This application claims the benefit of U.S. Provisional Application No. 61/730,502 filed on Nov. 27, 2012. The aforementioned provisional application is hereby incorporated by reference.

### BACKGROUND

In healthcare settings, attribution of a physician to a given patient is a growing concern. With the proliferation of physician reimbursements that are based patient outcomes, it is in a physician's interest to have accurate attribution in a given patient panel. Additionally, it is in the interest of payers (namely health plans, insurance providers, government entities, and self-funded employer plans) to ensure reimbursement to physicians in pay-for-quality models is accurate and payments are made to the physician most responsible for the care of a given patient. When a patient is attributed to a given physician, the physician becomes responsible for the patient's care. Typically, patients are in panels of primary care physicians (PCP), and the patient's care is attributed to the primary care physician.

An ongoing concern among payers is accurately identifying the correct PCP. This task can be complicated by patients who see multiple physicians.

Disclosed herein, is a method and system to correctly attribute patients to the correct physician.

### BRIEF SUMMARY

Disclosed herein is a system and method for attributing patients to panels of physicians in a healthcare setting via a computer network. Among the embodiments disclosed, are methods of attribution occurring by wherein physicians indicate a patient is added to a panel by a physician.

Alternative embodiments disclosed herein include methods wherein patients may select or approve a panel before being assigned to a panel. Embodiments where a payer approves or selects a panel are also disclosed.

### BRIEF DESCRIPTION OF THE DRAWINGS

FIG. 1 illustrates an embodiment of a system, including physicians, patients, and payers.

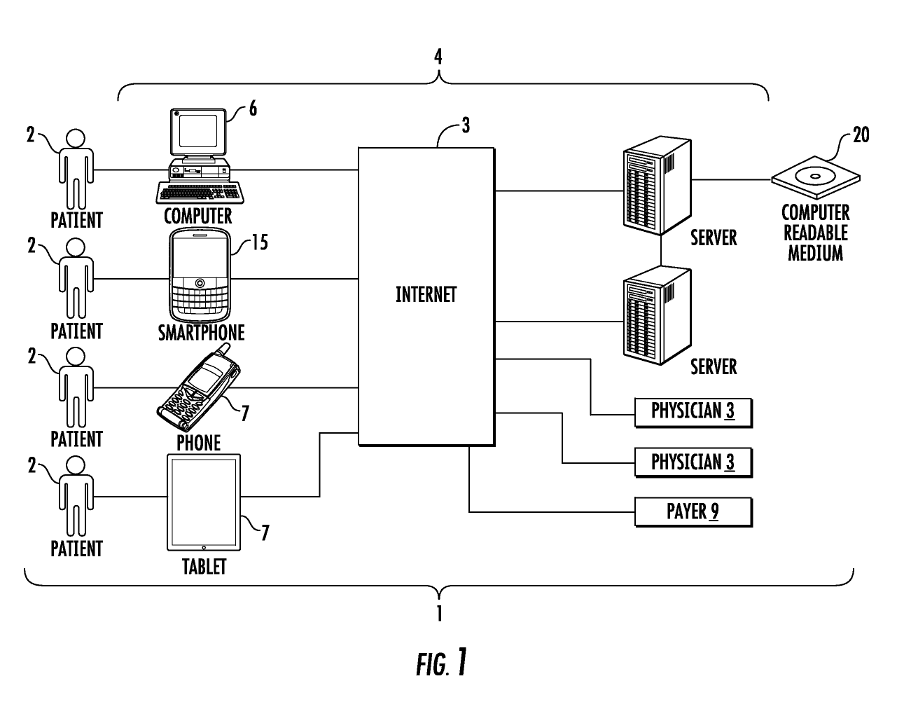

FIG. 2 illustrates an embodiment of a user interface wherein a physician can view a patient panel.

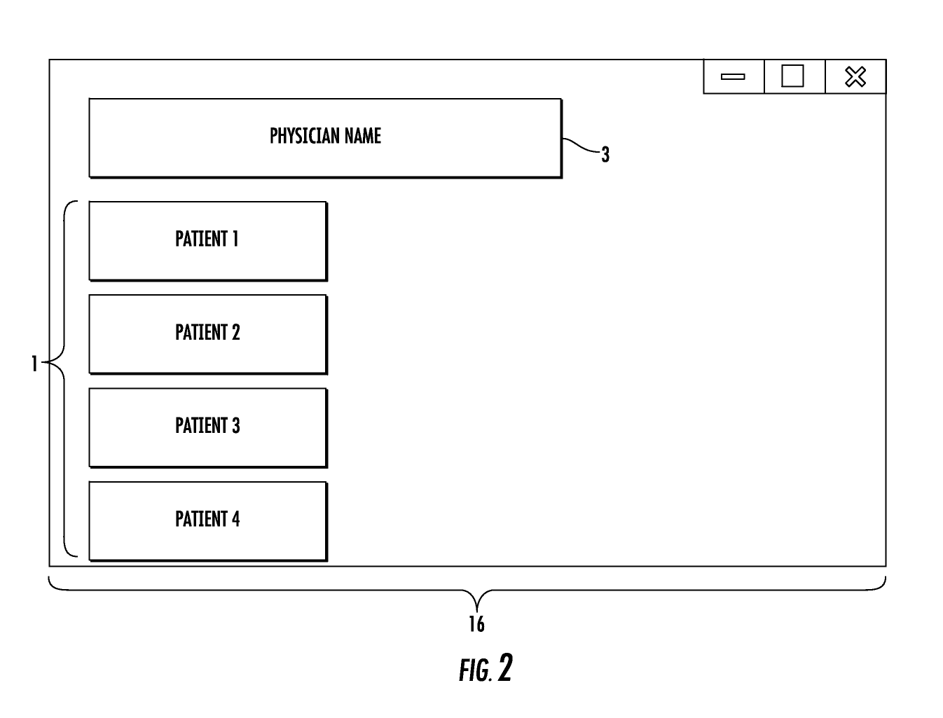

FIG. 3 illustrates an embodiment to determine patient attestation based on a clinical encounter.

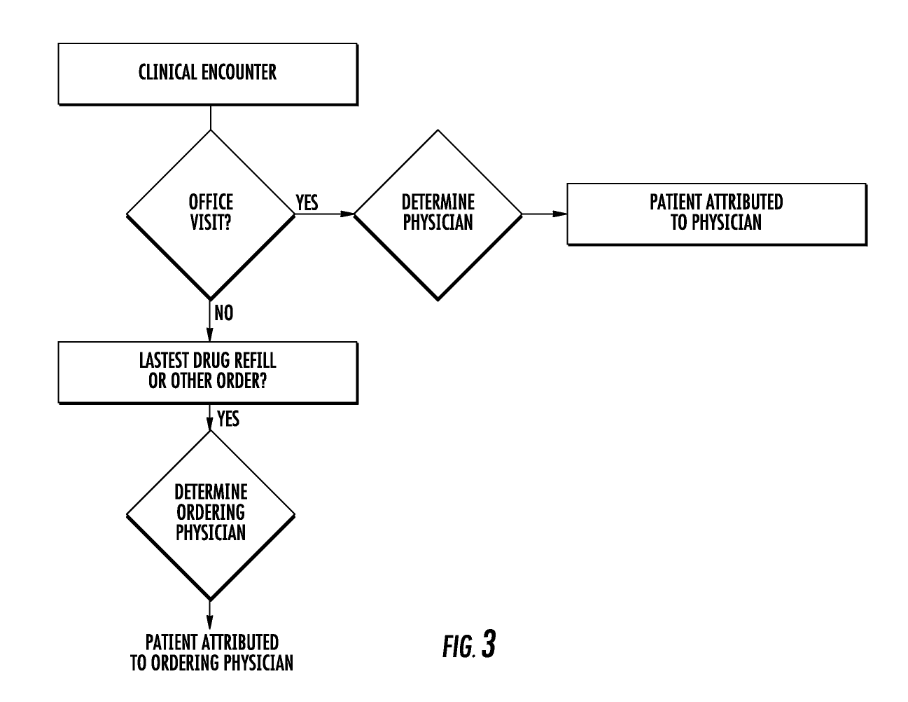

FIG. 4 illustrates an embodiment of a user interface wherein a physician can add or decline a patient to his panel.

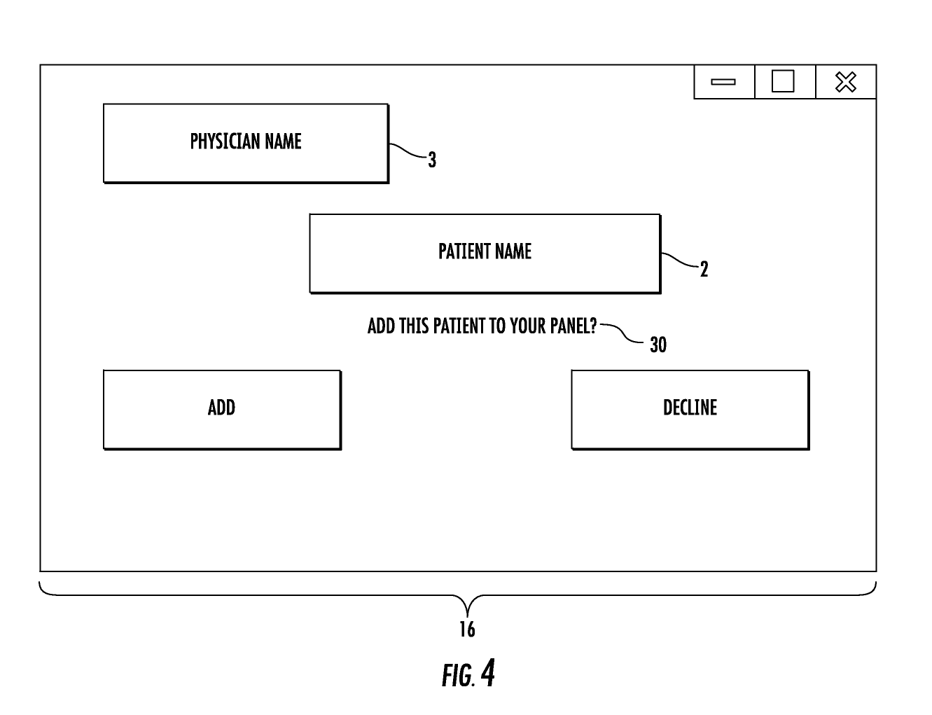

FIG. 5 illustrates an embodiment of a user interface wherein a physician can add supplemental data.

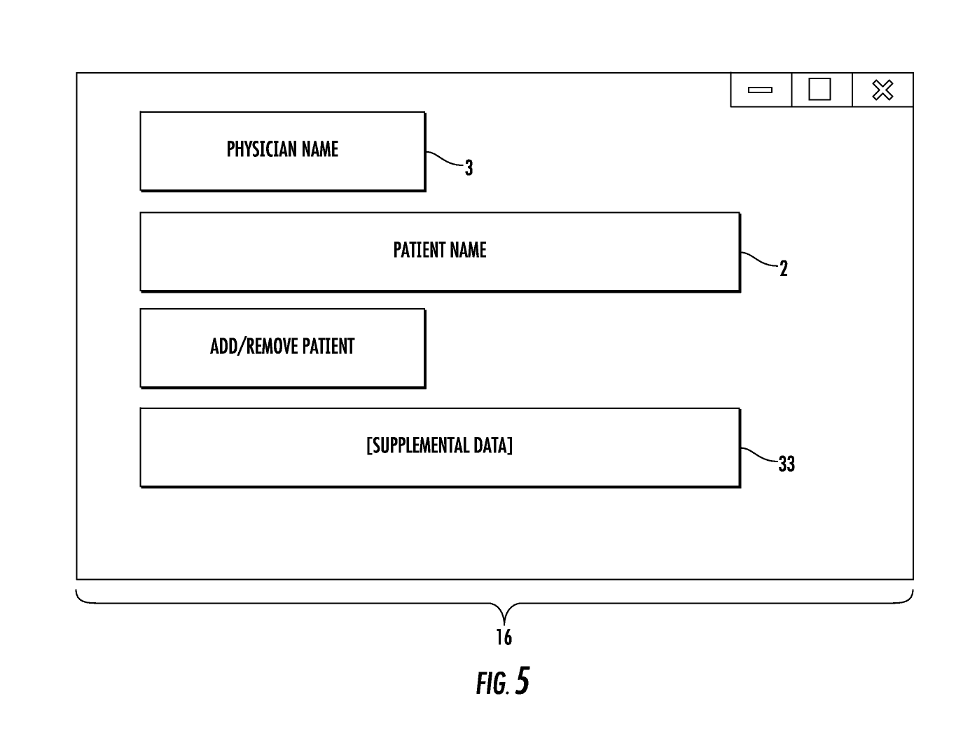

### DETAILED DESCRIPTION

Disclosed is a system 1 and method that properly attributes patients 2 to a physician 3. In certain embodiments, the object is to determine which physician 3 is most responsible a given patient's primary healthcare.

The system 1 is a network based computer system 1. Various embodiments of the methods disclosed herein are carried out over the network 4 based computer system 1. In some embodiments, the system 1 utilizes the Internet 5 to communicate with computers 6 and other electronic devices 7 and other devices 7 at remote locations 8. Remote locations 8 include offices of payers 9, medical offices 10, and patient homes 11. Information 12 relayed by the network 4 is displayed to end users on computer displays 13. In alternative embodiments, information 12 from the system can also be displayed on smartphones 15 and other electronic devices 7. In certain embodiments, devices 7 coupled to the system 1 will display a user interface 16 though which users 17 can view data 19 and input data into the system 1.

In certain embodiments, the system 1 comprises computer readable media. The computer readable media 20 contains non-transitory, computer executable instructions for carrying out one or more of the methods disclosed herein. In certain embodiments, the computer readable media 20 may be removed from the system 1 and function independent of the system 1.

Various data 19 are transmitted over the network 4 based computer system 1. Data 19 transmitted can include patient 2 demographic information 21 (such as name, social security number, health plan identification number, phone number, address, email address, username), patient 2 health information 22 (such as diagnosis, medical history, history of surgical procedures, prescription history, physician orders, progress notes, etc.), financial information 23 (such as information pertaining to reimbursement, insurance coverage, payment, etc.), and claims data 24 (such as data submitted to health plans by healthcare providers for purposes of reimbursement including CPT codes, ICD-9 codes and other codes used in healthcare). Additionally, some embodiments allow for patients to exchange messages and communicate directly with the physician 3 over the system 1. In certain embodiments, all data transmitted over or through the system can be accessed and obtained at a later time by the system 1 or physicians, patients, or payers. Alternatively, messages 25, such as email 26 messages and phone calls 27 between patients 2 and physicians 3, may be logged by the system 1. Much of this data 19 can be traced to a given physician 3. For example, data 19 entered by a physician 3 or a physician's delegate, can be traced to that particular physician 3, and it can be inferred that the entering physician 3 was involved in the treatment of the patient 2 for whom data 19 was entered. Further, claims data 24 submitted on behalf of a physician 3 for reimbursement can indicate that a patient 2 was treated by the physician 3 for whom a claim 25 was submitted to a payer 9. Data 19 in a patient's 2 medical history 28 indicating a given physician 3 was involved in the care or the patient 2 at some point in time would indicate that a patient 2 was receiving care from the physicians 3 appearing in the medical history 28.

As necessary, the system 1 will obtain approval from patients 2, physicians 3, and payers as needed. The system 1 will also display various messages and request various approvals through a user interface 16. All such approvals are stored on the system and may be viewed by patients, physicians, and payers in certain embodiments.

Each physician 3 listed as a provider on a database 29 residing on the system 1 has a panel 30 of patients. The patients 2 comprising the panel 30 are determined according to various embodiments disclosed. In various embodiments, the panel 30 is viewable to the physician 3, the physician's 2 delegates, and payers 9. Some embodiments allow patients 2 to view the physician 3 to whom they are attributed over the system 1.

Actual attribution of patients 2 to a given physician's 3 panel 30 can occur in a number of ways. In certain embodiments, physicians 3 and delegates of physicians 3 have the ability to add patients 2 to a physician panel 30. In certain embodiments, such attribution occurs through a user interface 16. The user interface 16 is displayed in a web browser 31 or other electronic platform. Through the user interface 16, a physician 3 indicates a given patient 2 is part of the physician's panel 30. Conversely, a physician 3 can transfer patients 2 out of his panel 30 through the user interface 16. This may occur unilaterally though the user interface 16 when the physician 3 removes the patient 2 from his panel 30. In an alternative embodiment, transfer of a patient 2 out of a physician 3 panel 30 will occur only when two physicians 3 voluntarily agree to a transfer of a patient 2 from one physician's 2 panel 30 to another. In this instance, the system will obtain approval from the physicians involved. In this embodiment, the transferring physician 3 will use the user interface 16 to indicate his intent to transfer a patient 2. In some embodiments, a message will be generated and sent to a receiving physician 3, giving the receiving physician 3 the ability to accept the patient 2 into the receiving physician's panel 30 through the user interface 16. A receiving physician 3 may then accept the patient 2 into the receiving physician's panel 30 through the user interface. In some embodiments this acceptance can be achieved through clicking “accept”, or a similar message, in the user interface 16.

Certain embodiments utilize a three-way handshake between physician 3, patients 2, and payers 9. In this embodiment, payers 9 are health insurance providers or managed care organizations. In some embodiments, patients 2, physicians 3, and payers 9 all need to be in agreement before a patient will be attributed to a given physician's panel 30.

Some embodiments allow for implicit attestation. Implicit attestation occurs when a physician 3 has any encounter with a patient 2. An encounter 32 can be a clinical encounter in the office, or it could be an exchange of messages over the computer system 1. When such an event occurs and is recognized by the system, a patient 2 may be automatically attributed to a physician 3 with whom a patient had a clinical encounter 32. The frequency of clinical encounters 32 can also be a factor in implicit attestation. For example, a patient who has seen multiple physicians 3 may be attributed to the physician 3 with whom the patient 2 has the most clinical encounters 32. Alternatively, a patient 2 may be attributed to the physician 3 the patient 2 has seen most recently. In certain embodiments, the system 1 will recognize factors such as claim data 24 and appointment records to implicitly attribute a patient 2 to a physician 3. In certain embodiments, prescription drug refills, laboratory orders, and other physicians orders, made for specific patients, will result in that patient being attributed to the ordering physician's panel 30.

In certain embodiments, supplemental data 33 can be entered by a physician 3, or a physician's 3 delegate. Supplemental data 33 is additional data that is not already available to the system 1 or the databases residing on the system. For example, supplemental data 33 can include information that does not ordinarily appear in a patient's medical record, or data that may not be clinically relevant. Supplemental data 33 may also include information a physician 3 believes is relevant to determining attribution but is not evident to the system 1. Supplemental data can be used, in certain embodiments, to override implicit attestation when extrinsic factors, or the judgment of the physician, indicate that attribution of a given patient 2 to a physician's panel 30 is inappropriate.

In certain embodiments, patients must approve an attribution to remain on a panel 30. In such instances, the system 1 will request approval from the patient 2. If the patient 2 approves that attribution, the patient will remain on the panel 30. If the patient 2 declines the attribution, the patient will be removed from the panel 30. Patients may be

In certain embodiments, an attribution file 34 is received from a payer 9 at fixed intervals. The attribution file 34 links each patient 2 with a single physician 3. The payer then utilizes various criteria to determine which physician 3 each patient 2 should be attributed to. Criteria that may be considered in certain embodiments include whether a patient 2 explicitly selected physician 3 (explicit attestation by the physician), claims activity from a physician 3 seeking reimbursement for treatment of a patient 2, or data 19 from the system 1 that indicates that a physician 3 has explicitly added or removed a patient from her panel 30.

In certain embodiments, the physician 3 can manually add patients 3 to his panel 30 or decline patients 2 who are already in his panel. In certain embodiments, this is done with Add/Decline button that is visible on the user interface 16. This results in the physician's panel 30 being immediately changed and a message being sent to a payer 9 to indicate changes made by the physician 3 to his panel 30. In certain embodiments, when a physician 3 declines to add a patient 2 to his panel or when a physician 3 removes a patient 2 from his panel 30, the physician 3 can suggest another physician 3 to whom the patient 2 should be attributed. In this instance, the patient 2 may appear as a “suggestion” to another physician 3 on the user interface 16. Some embodiments provide for an “add” button that will instantly add the patient to the suggested physician's panel 30 if clicked.

In certain embodiments, patients 2 may request to be attributed to a given physician 3. In this instance, patient will select a given physician 3 through the user interface as the patient's physician 3. In certain embodiments, this will be sufficient to add a patient 2 to the physician's patient panel 30. In other embodiments, it is necessary for the physician to agree to the attestation of this patient through the user interface 16. In other embodiments, it will be necessary for a payer 9 to approve the attribution of the patient 2 to the physician 3 before the patient 2 will be added to the physician's panel 30.

In certain embodiments, payers 9, and employees of payers, are able to access physician patient panels 30 through the system 1. Payers are able to view the panels through a user interface 16. In some embodiments, payers may approve the attribution of patients to a panel. The approval occurs after a patient 2 has been added to a panel 3 though any means disclosed herein. Through the user interface, a payer may approve or deny an addition to a physician's panel. Additionally, in certain embodiments, payers may approve or deny the removal of a patient from a panel. In certain embodiments, payers may also add and remove patients from physician panels unilaterally, and without approval or action by patients or physicians.

In certain embodiments, the user interface will display statuses of patients within the physician's panel. The status of each patient is visible to physicians and payers on the user interface. Patients who have been on a physician's panel for more than a month will have a “current” status. Patients who have been on a physician's panel for less than a month will have a status of “new”. In embodiments where approval from a payer may be necessary, the status of a patient added to a panel will be “added”. The status will appear as “added” until the addition to the physician's panel has been approved by a payer. If the addition is not approved, the patient will be removed from the panel and will not have a corresponding status visible on the user interface. If a patient is deleted from a physician's panel by a physician, the patient will appear as “deleted” on the user interface until the deletion is approved by the payer. If the deletion is approved, the patient will be removed from the physician's panel. If the deletion is not approved, the status associated with the patient will be “current”. If a patient id transferred from a transferring physician to a receiving physician, the patient's status will appear as “transferred” until approval is obtained from either the payer, the receiving physician, or both the payer and the receiving physician. After approval for the transfer is obtained, the patient's status will be “left” in the transferring physician's panel and “transferred” in the receiving physician's panel. A month after the approval of the transfer, “left” and “transferred” statuses will no longer be applied to the transferred patient.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable. Additionally, it should be understood that the term “physician”, as used herein, may be applied to any health care provider, including, without limitation, nurses, nurse practitioners, physician assistants, chiropractors, physical therapists, medical technologists, psychologists, counselors, and healthcare organizations.

What is claimed is:

1. A method for attributing patients to physicians comprising the steps of:
obtaining health insurance claims data;
determining a patient for whom said health insurance claims data pertains;
determining a physician who submitted the claims data; and
adding the patient for whom said health claims data pertains to a panel associated with the physician who submitted the claims data.

2. The method for attributing patients to physicians of claim 1 further comprising the step of obtaining approval from a payer to maintain the addition of the patient for whom said health insurance claims data pertains.

3. The method for attributing patients to physicians of claim 1 further comprising the step of obtaining approval from the patient to remain on the panel of the physician who submitted claims data.

4. A method for transferring patients between the panels of two physicians comprising the steps of:
receiving a request from a transferring physician to transfer a patient from a transferring physician's panel;
displaying a request to a receiving physician to add the patient to a receiving physician's panel; and
receiving an acceptance to add a patient to the receiving physician's panel from the receiving physician.

5. The method for transferring patients between the panels of two physicians of claim 4, further comprising the step of obtaining approval from a payer for the transfer.

6. The method for transferring patients between the panels of two physicians of claim 4 further comprising the step of obtaining approval from a patient for the transfer.

7. The method for transferring patients between the panels of two physicians of claim 4 wherein statuses of the transferred patient are displayed to the transferring physician and the receiving physician after approval is obtained from a payer.

8. A non-transitory computer-readable medium having computer-executable instructions for attributing patients to physicians comprising, said computer-executable instructions comprising the steps of:
obtaining health insurance claims data;
determining a patient for whom said health insurance claims data pertains;
determining a physician who submitted the claims data; and
adding the patient for whom said health claims data pertains to a panel associated with the physician who submitted the claims data.

9. The non-transitory computer-readable medium having computer-executable instructions for attributing patients to physicians comprising, of claim 8, said computer-executable instructions further comprising the step of obtaining approval from a payer to maintain the addition of the patient for whom said health insurance claims data pertains.

10. The non-transitory computer-readable medium having computer-executable instructions for attributing patients to physicians comprising, of claim 8, said computer-executable instructions further comprising the step of obtaining approval from the patient to remain on the panel of the physician who submitted claims data.
